(19) United States
(12) Patent Application Publication
(10) Pub. No.: US 2018/0238365 A1
(43) Pub. Date: Aug. 23, 2018

(54) A MODULAR PLAYGROUND APPARATUS

(71) Applicant: GILLATT FAMILY INVESTMENTS PTY LTD, New South Wales (AU)

(72) Inventors: Ryan Gillatt, New South Wales (AU); Ben McMahon, New South Wales (AU); Lee Liston, New South Wales (AU)

(21) Appl. No.: 15/551,082

(22) PCT Filed: Feb. 12, 2016
(86) PCT No.: PCT/AU2016/050086

§ 371 Date: Aug. 15, 2017

(30) Foreign Application Priority Data
Feb. 16, 2015 (AU) 2015900502

(51) Int. Cl. F16B 7/18; A63B 9/00; E04B 1/58

(52) U.S. Cl. CPC F16B 7/185; A63B 9/00; A63B 2210/50; A63B 2009/006; E04B 1/585

(57) ABSTRACT

The present invention relates broadly to a rail joint assembly and relates particularly, although not exclusively, to a play apparatus incorporating said joint assembly and a method for constructing a play apparatus comprising a framework structure of interconnected rail members and a plurality of said joint assemblies. The play apparatus comprises a framework structure including interconnected rail members and a plurality of joint assemblies each arranged to interconnect at least a pair of the rail members to construct the framework structure. Each of the joint assemblies includes a structural hub configured for detachable connection to an end of one of the rail members and a joint housing mounted about the structural hub and including one or more bracket anchorages for securement of one or more panel brackets to which a panel of the play apparatus is removably mounted.

### TECHNICAL FIELD

The present invention relates broadly to a rail joint assembly and relates particularly, although not exclusively, to a play apparatus incorporating said joint assembly.

### BACKGROUND OF INVENTION

In attracting children to play equipment there are ongoing challenges for designers to construct equipment which is appealing, fun to interact with, and safe. The play equipment or playground may be constructed from a framework structure which is clad in moulded plastic panels. The framework structure provides the requisite stability for the playground. The moulded panels function to both enclose the playground and provide visual appeal through graphics and bright colours.

The fabrication and construction of playgrounds is typically quite complicated or technical requiring a range of tooling and trade skills. This means the playground is not only expensive to fabricate but also costly to erect. Once built the playground does not lend itself to being reconfigured where, for example, an extension is required to include additional play space or play equipment. The playground may be prefabricated with its footprint requiring a minimum space in either or both the horizontal and vertical dimensions. This means it may be difficult to fit the playground in the available space.

### SUMMARY OF INVENTION

According to a first aspect of the present invention there is provided a play apparatus comprising:

a framework structure including interconnected rail members;

a plurality of joint assemblies each arranged to interconnect at least a pair of the rail members to construct the framework structure, each of the joint assemblies including:
a structural hub configured for detachable connection to an end of one of the rail members;
a joint housing mounted about the structural hub and including one or more bracket anchorages for securement of one or more panel brackets to which a panel of the play apparatus is removably mounted.

According to a second aspect of the invention there is provided a rail joint assembly for a play apparatus, said joint assembly comprising:

a structural hub adapted for detachable connection to an end of a rail member of the play apparatus;

a joint housing mounted about the structural hub and including one or more bracket anchorages for securement of at least one panel bracket to which a panel of the play apparatus is removably mounted.

Preferably the structural hub includes a plurality of spigots each dedicated for connection to respective of the rail members associated with the rail joint assembly to construct the framework structure. More preferably the structural hub includes three (3) intersecting pairs of the spigots arranged substantially orthogonal to each other with one spigot of the pair substantially aligned with the other spigot of the pair. Even more preferably the structural hub is formed in one-piece with the pairs of intersecting spigots extending from a core of the structural hub.

Preferably the panel brackets each include a mounting tang which is generally elongate and configured for fastening at its opposite ends to the joint housing and the panel, respectively. More preferably the mounting tang is screw fastened or bolted to the joint housing to locate the mounting tang in substantially the same plane as the panel.

Preferably the joint housing is substantially hollow and generally spherical in its outside shape. More preferably the spherical housing fully encloses the structural hub and includes rail openings for respective of the rail members associated with the rail joint assembly. Even more preferably the bracket anchorages include one or more flanged connections located inside the hollow housing and screw fastened or bolted to the mounting tang via bracket fasteners.

Preferably the joint housing includes one or more window openings for access to the bracket anchorages to assist with securement of the panel bracket to which the panel is mounted. More preferably the joint housing includes bracket openings designed for receipt of the panel bracket. Even more preferably the window openings each include a cover member for closure of the respective window opening.

Preferably the joint housing is of a 2-piece construction with opposing hemi-spherical shells being substantially the same. More preferably the opposing hemi-spherical shells are secured to one another.

Preferably the rail members are hollow and substantially straight.

Preferably the framework defines the play apparatus in a series of adjoining cubes.

Preferably the play apparatus is modular.

The play apparatus of any one of the preceding claims, wherein the panel includes one or more arc shaped corners for closely adjoining the complementary shaped structural housing.

In another aspect, the invention provides a method for constructing a play apparatus comprising a framework structure of interconnected rail members and a plurality of joint assemblies, the method including:

connecting a structural hub to an end of one of the rail members;
mounting a joint housing about the structural hub to form a joint assembly;
securing one or more panel brackets to bracket anchorages of the joint housing; and
mounting one or more panels of the play apparatus to the panel brackets.

The method can include connecting the structural hub to the ends of a plurality of the rail members and clamping hemi-spherical shells of the joint housing together about the structural hub.

### BRIEF DESCRIPTION OF DRAWINGS

In order to achieve a better understanding of the nature of the present invention a preferred embodiment of a play apparatus together with a rail joint assembly for a play apparatus will now be described, by way of example only, with reference to the accompanying drawings in which:

FIG. 1 is a perspective view of a partially constructed play apparatus according to one embodiment of the invention comprising a number of rail joint assemblies interconnecting a plurality of rail members with panels and a slide mounted thereto;

FIG. 2 is a perspective view of a partially constructed play apparatus according to another embodiment of the invention;

FIG. 3 is a perspective view of the structural hub of the rail joint assembly detachably connected to ends of two of the rail members of the apparatus embodiments of FIGS. 1 and 2;

FIG. 4 is a perspective view of the rail joint assembly detachably connected to ends of four of the rail members and a panel of the apparatus embodiments of FIGS. 1 and 2;

FIG. 5 is a perspective view of the rail joint assembly detachably connected to ends of six of the rail members and three panels of the apparatus embodiments of FIGS. 1 and 2;

FIG. 6 is a perspective view of two of the rail joint assemblies detachably connected to ends of a plurality of the rail members and a plurality of panels of the apparatus embodiments of FIGS. 1 and 2;

FIG. 7 is a perspective view of the rail joint assembly of the partially constructed play apparatus embodiments of FIGS. 1 and 2 and in accordance with another aspect of the invention;

FIG. 8 is a perspective view of the rail joint assembly of FIG. 7 shown in a different configuration;

FIGS. 9 and 10 are partly exploded perspective views of the rail joint assembly of FIGS. 7 and 8;

FIG. 11 is a partly exploded perspective view of the rail joint assembly of FIGS. 7 to 11 with some components removed for clarity;

FIG. 12 is a partly exploded perspective view of the rail joint assembly of FIGS. 7 to 11 with some components removed for clarity;

FIG. 13 is a part exploded perspective view of the rail joint assembly of FIGS. 7 to 12 with part of its associated joint housing removed for clarity.

### DETAILED DESCRIPTION

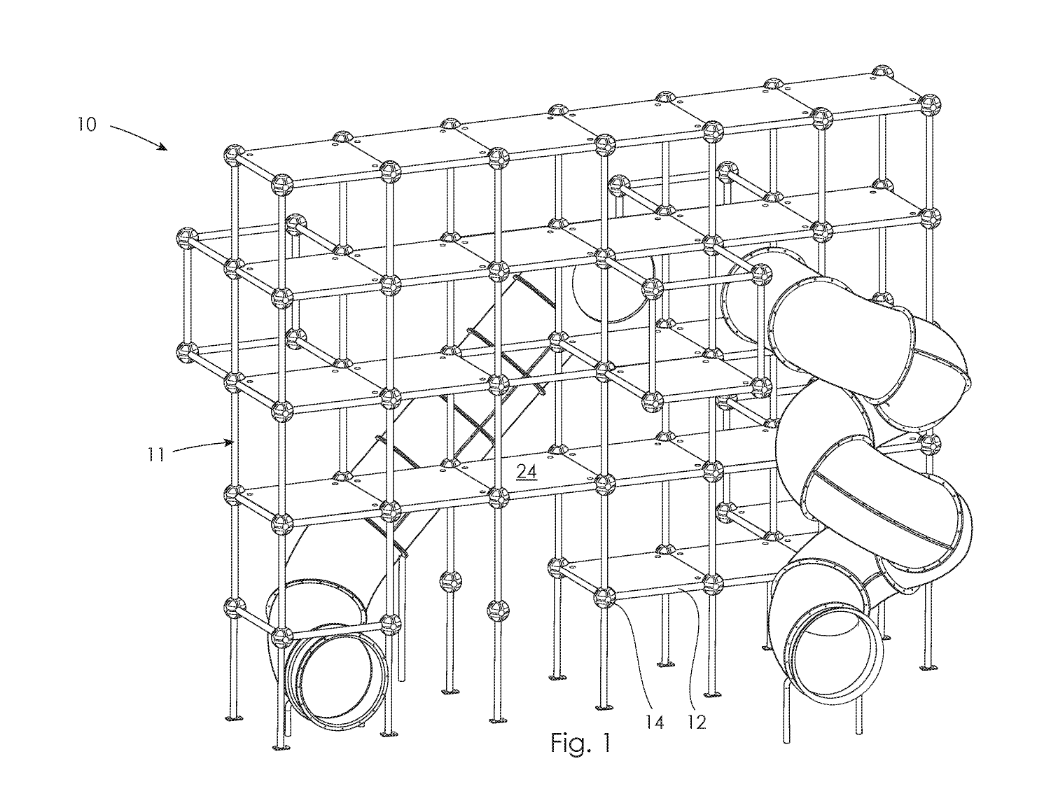

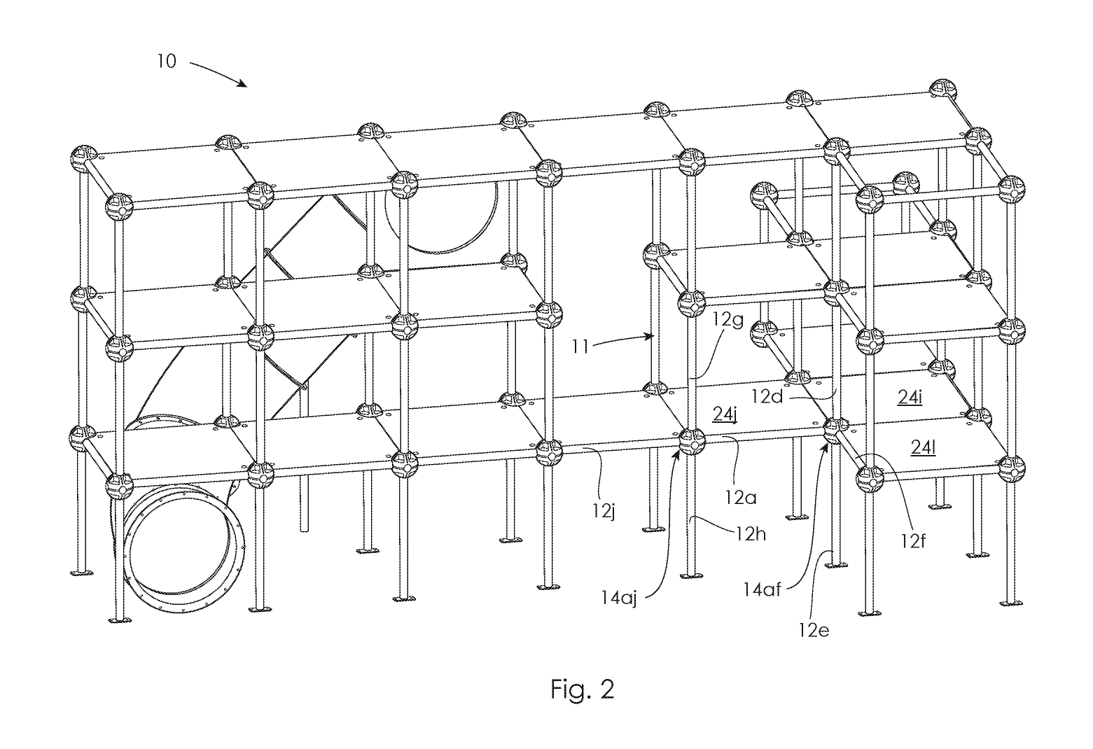

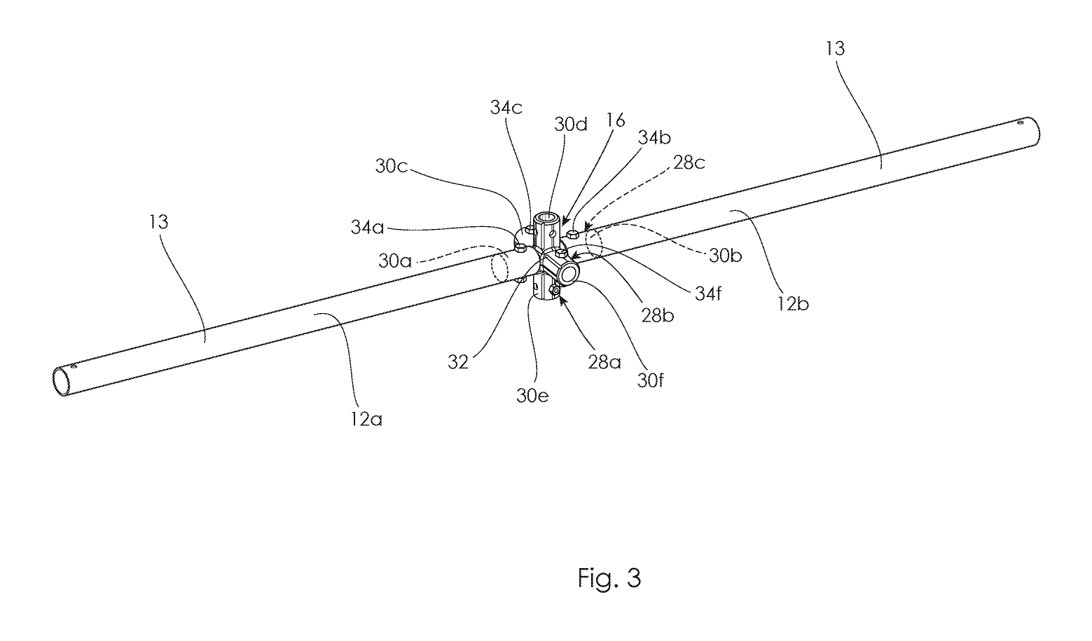

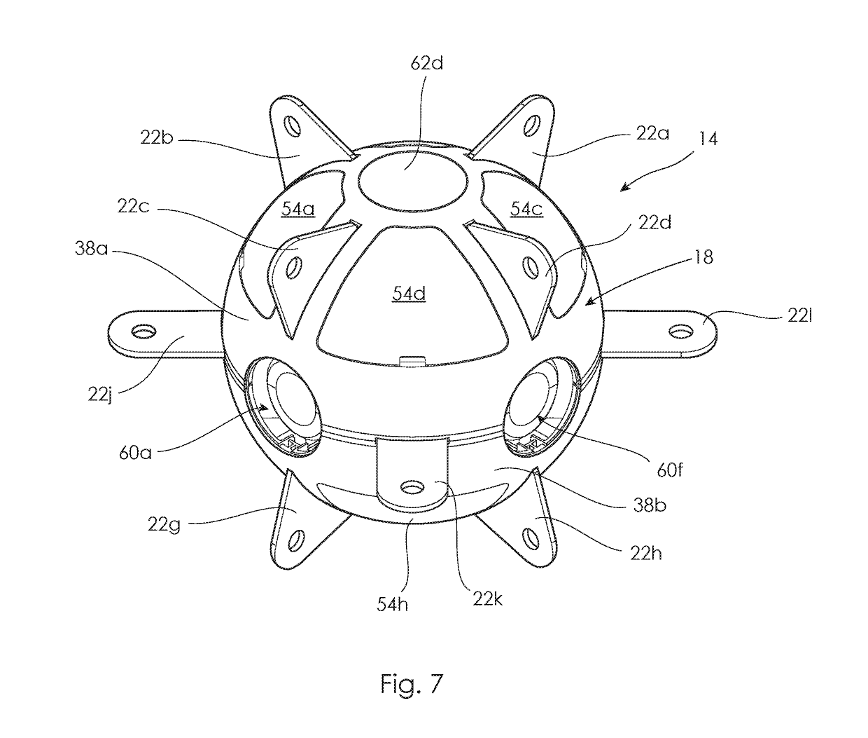

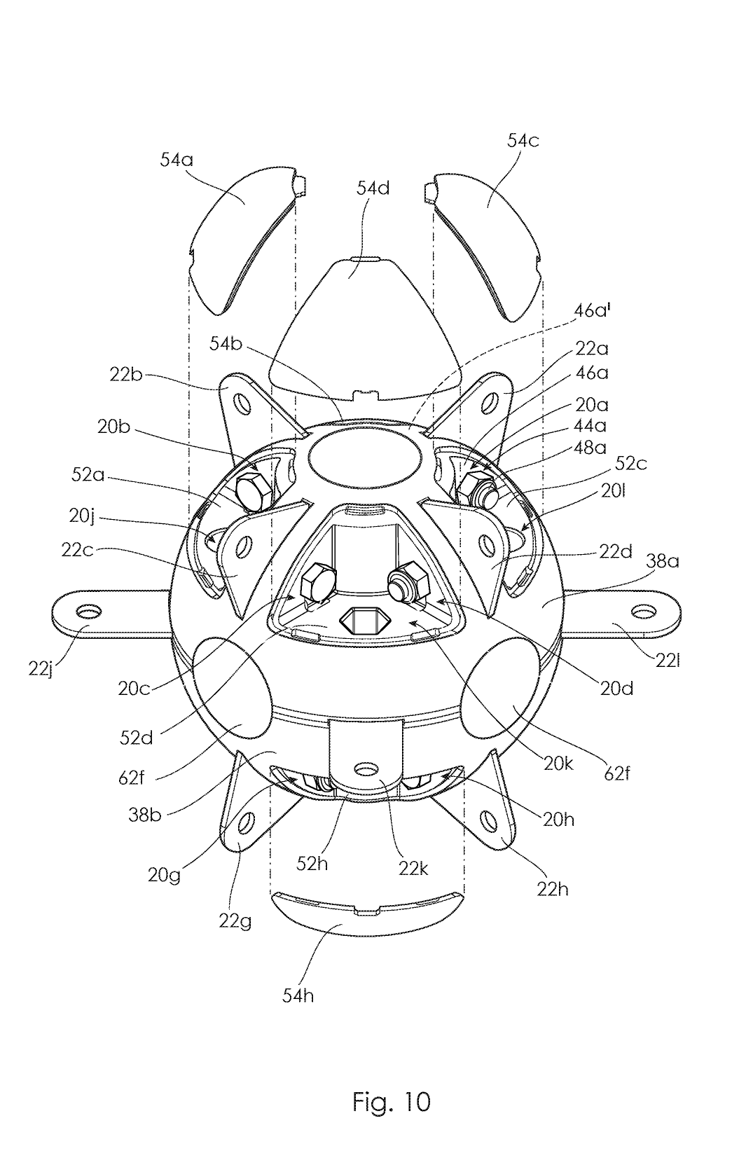

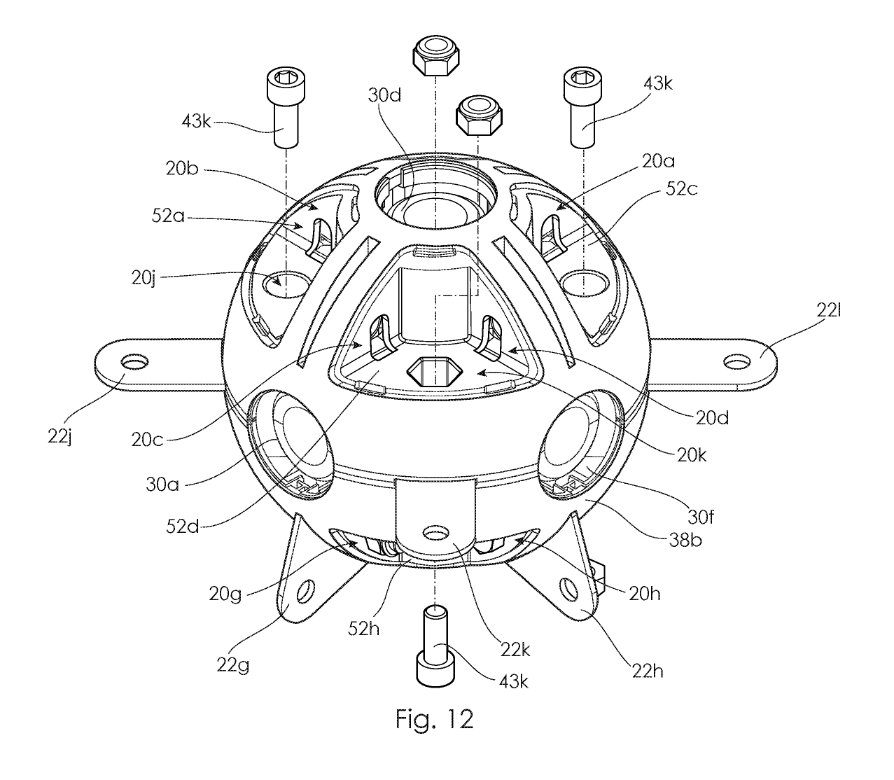

As shown in FIGS. 1 and 2 there is a partially constructed or partly completed play apparatus of alternative embodiments of an aspect of the invention. FIGS. 2 to 6 show the play apparatus at various stages of construction according to this aspect of the invention. The play apparatus is in the form of a modular child's playground 10 comprising a framework structure designated generally at 11 including a matrix of interconnected rail members 12 such as the rail members 12a to 12i shown in FIGS. 2 to 6. The rail members 12 such as the rail members 12a to 12f of FIGS. 2 to 6 are interconnected by a rail joint assembly 14 such as the rail joint assembly 14af of FIGS. 2 to 6. The play apparatus 10 comprises other joint assemblies such as 14aj interconnecting rail members 12a and 12g to 12j of FIGS. 2 to 6. Each of the joint assemblies 12 such as the joint assemblies 14af and 14aj are of substantially the same construction including:
1. a structural hub 16, as illustrated in FIG. 3 in particular, configured for detachable connection to an end of one of the rails such as 12a; and
2. a joint housing 18, as illustrated in FIGS. 1, 2 and 4 to 13 and in FIGS. 7 to 13 in particular, mounted about the structural hub 16.

As seen in FIGS. 7 to 13 the joint housing 18 includes one or more bracket anchorages such as 20a to 201 for securement of respective panel brackets such as 22a to 22l. The panel brackets 22a to 22l are dedicated for mounting of respective panels such as 24a to 24l of the play apparatus 10.

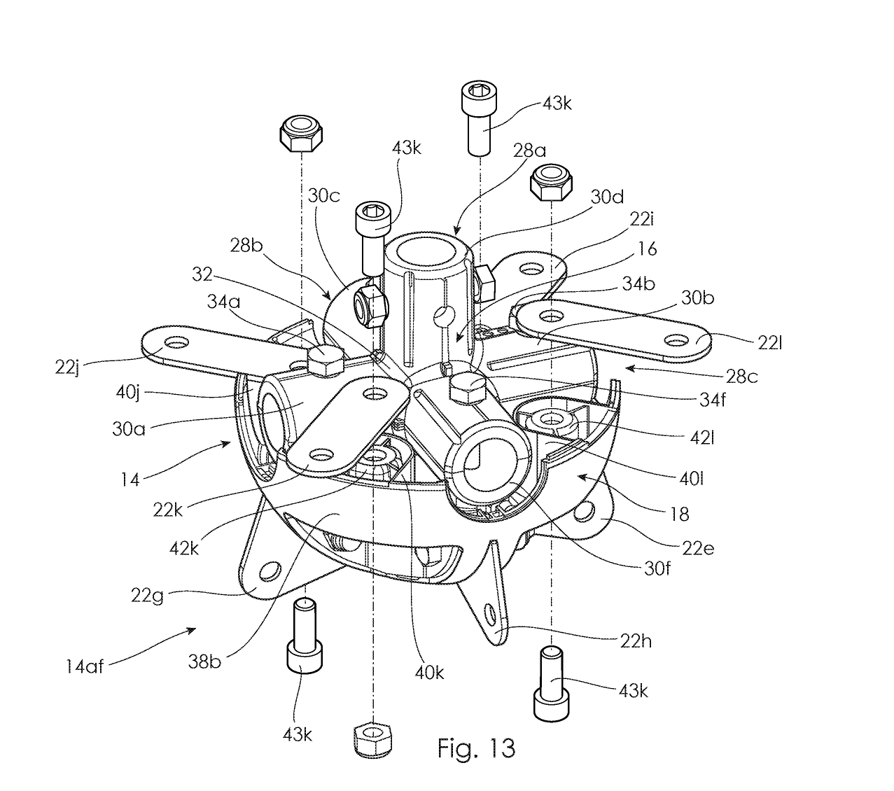

As best seen in FIGS. 3 and 13 the structural hub 16 of the illustrated embodiment includes three (3) intersecting pairs of spigots 28a to 28c arranged substantially orthogonal to each other. For each of the pairs of spigots such as 28a, 28c one spigot 30d, 30a of the pair is substantially aligned with the other spigot 30e, 30b of the pair. Each of the spigots such as spigots 30a and 30b is, as illustrated in FIG. 3, dedicated for connection to respective of the rail members in this case 12a and 12b. The structural hub 16 is formed in one-piece with the pairs of intersecting spigots 28a to 28c extending from a core 32 of the structural hub 16. The rail members such as 12a, 12b and 12c, 12f of FIGS. 2 to 6 are fastened to respective spigots 30a, 30b and 30c, 30f via respective fasteners such as bolts 34a, 34b and 34c, 34f.

In the aforementioned embodiment, the panel brackets such as 22a to 22l are each generally elongate and designed for fastening at opposite ends to the joint housing such as 18 and one of the panels such as 24a to 24l as illustrated in FIGS. 2 and 4 to 6. The panel brackets 22a to 22l are in the form of either:
1. a trapezoidal-shaped mounting tang, preferably with rounded corners, which is oriented vertically when dedicated to fastening a wall panel such as 24a; or
2. a rectangular-shaped mounting tang, preferably with rounded corners, which is oriented horizontally when dedicated to fastening a deck panel such as 24i and 24j.

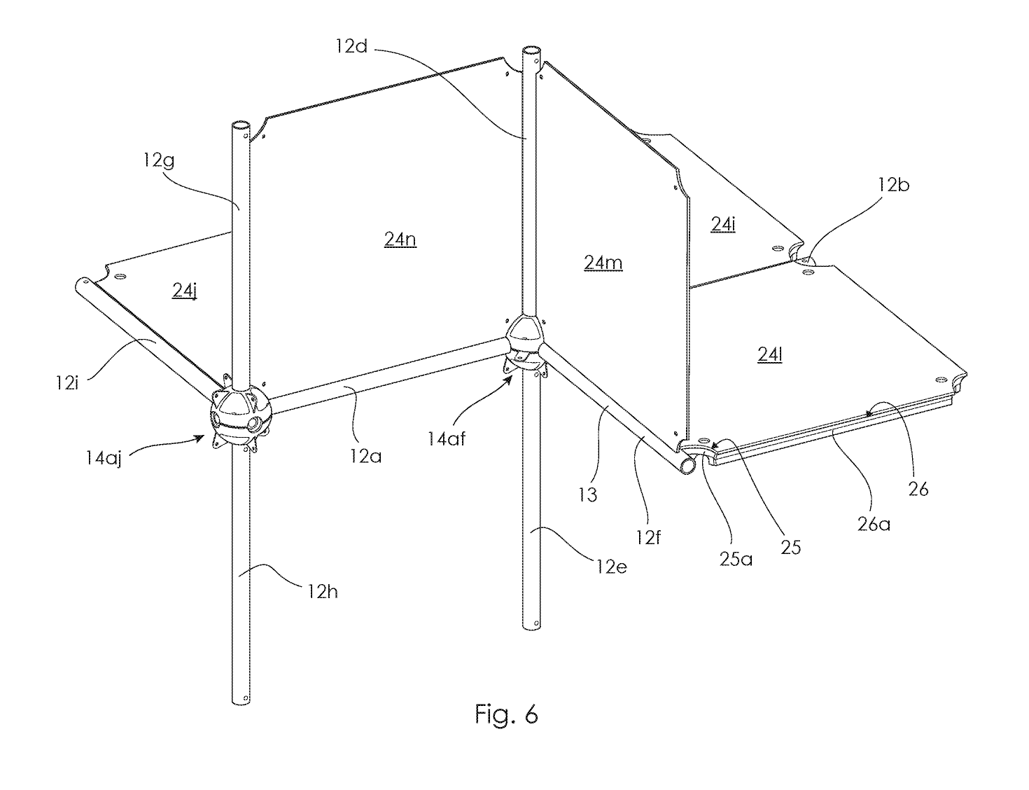

In this embodiment and as best seen in FIGS. 7 to 13 the joint housing 18 is substantially hollow and generally spherical in its outside shape. The spherical shape of the joint housing 18 is configured to cooperate with a complementary arc shaped corner region 25 of each of the deck panels 24i to 24j such as deck panel 24l illustrated in FIG. 6. Each arc shaped corner region 25 which exists at up to all four corners of each of the deck panels 24i to 24j such as deck panel 24l, includes a curved surface portion 25a for closely facing or abutting with the outer spherical shaped surface of the joint housing 18. The aforementioned interaction between the complementary arc shaped corner region 25 of the deck panels 24i to 24j, and preferably also the curved surface portion 25a thereof, and the outer spherical shaped surface of the joint housing 18 is advantageous in distributing load from the deck panels such as 24i to 24j to the joint housing 18 and/or allowing a close fit therebetween which is important in preventing items of clothing and fingers caught in the gap therebetween.

The spherical housing 18 is of a two-piece construction with opposing hemi-spherical shells 38a and 38b being substantially the same. Each of the hemi-spherical shells 38a or 38b is divided into four quadrants dedicated to respective of either the deck mounting tangs such as 22i to 22l, or the wall mounting tangs such as 22a to 22d, or 22e to 22h (of which 22e, 22g, 22h are shown in FIGS. 13 and 22f is obscured and not shown). The deck mounting quadrants each include a deck bulkhead such as 40i to 401 formed integral with a mounting boss such as 42i to 42l.

The deck mounting tangs 22i to 22l are clamped between the hemi-spherical shells 38a and 38b via deck mounting bolts such as 43k located within the respective mounting bosses such as 42k. The wall mounting tangs such as 22a to 22d are fastened or otherwise secured to respective of flanged connections such as 44a to 44d in the form of a pair of gussets 46a and 46a′. The gussets 46a and 46a′ bridge the adjacent bulkhead such as 40l and the associated hemi-spherical shell 38a. The wall mounting tang such as 22a is sandwiched between the pair of gussets 46a and 46a′ and secured with an appropriate fastener such as a wall mounting bolt 48a.

The relevant panel brackets such as 22a to 22l are thus fastened to the joint housing in substantially the same plane as the panel such as deck panels 24i to 24j and wall panels such as well panel 24a to which they are to be secured. In this example the bracket anchorages 20a to 201 are provided by (i) either the deck bulkhead such as 40i to 401 and its associated mounted bosses 42i to 421, or (ii) the flanged connections such as 44a to 44d formed integral with the spherical housing 18. The deck panels such as 24i nest within the surrounding rail members such as 12b and 12c which thus bear the load of the panel 24i and any occupants upon the panel 24i. To this end, the deck panels such as 24i have at least one and preferably four like edge regions 26 which have an arcuate form in transverse cross section thus providing an elongated and curved edge surface 26a. The curved edge surface 26a abuts with or at least closely faces a complementary shaped rounded external surface 13 of the rail members 12, such as rail members 12a and 12f, as can be seen in FIGS. 2 to 6 and in FIG. 6 in particular. The aforementioned features are important in distributing load from the deck panels such as 24i to the rail members 12, such as rail members 12a and 12f, and/or in minimising gaps between structural members of the play apparatus 10 for preventing items of clothing or fingers getting caught in the gap therebetween. The panel brackets such as 22i serve to prevent movement or dislodgement of the deck panel 24i in an upward direction.

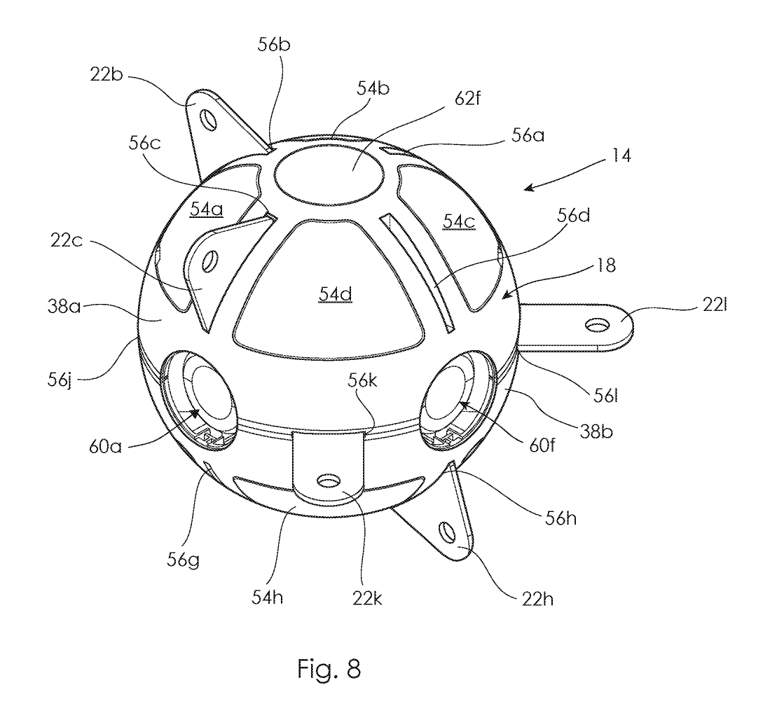

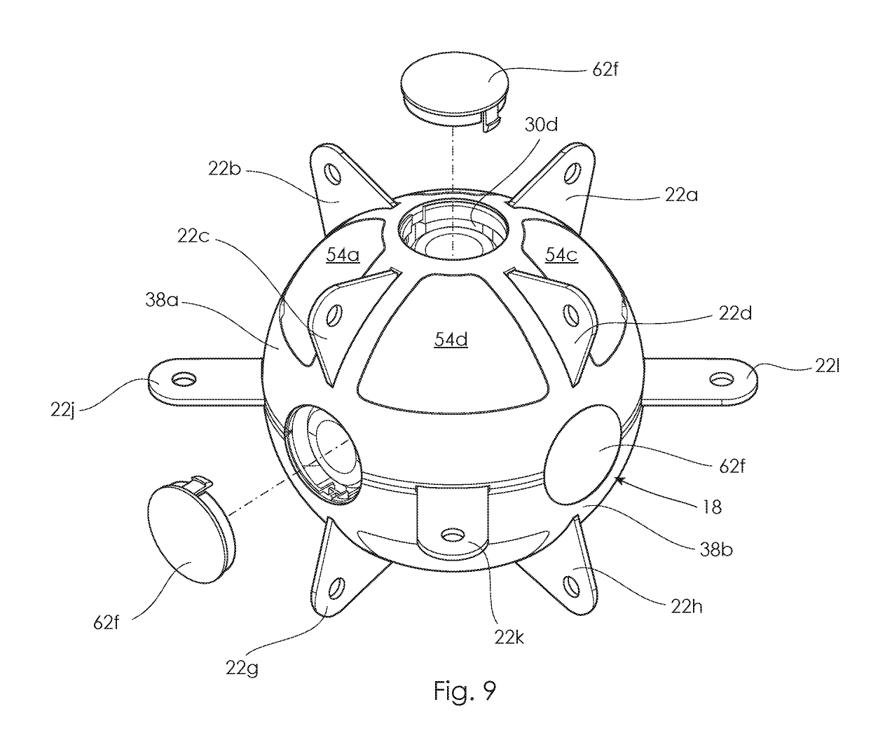

The joint housing 18 of this embodiment also includes a series of window openings 52a to 52h designed to provide access to the bracket anchorages such as 20a to 20l. This means the rail joint assembly such as 14 can be reconfigured for different deck and wall configurations without dismantling the joint housing 18. As best seen in FIGS. 8 to 10, the window openings such as 52a to 52h are each enclosed by respective cover members 54a to 54h. The joint housing 18 also includes bracket openings in the form of bracket slots such as 56a to 561 aligned for receipt of the respective panel bracket 22a to 22l. The joint housing 18 further includes rail ports such as 60a to 60f aligned with corresponding spigots 30a to 30f for entry of the relevant rail member 12a to 12f. The rail ports such as 60f when not occupied with a rail member may be closed with a rail port cover such as 62f, as illustrated in FIG. 9 in particular.

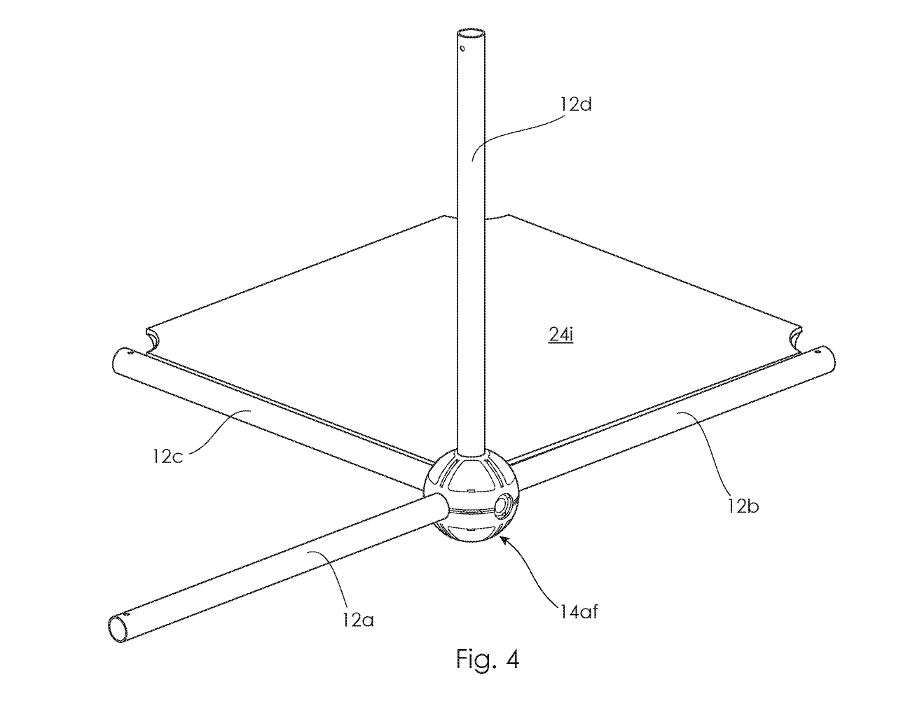

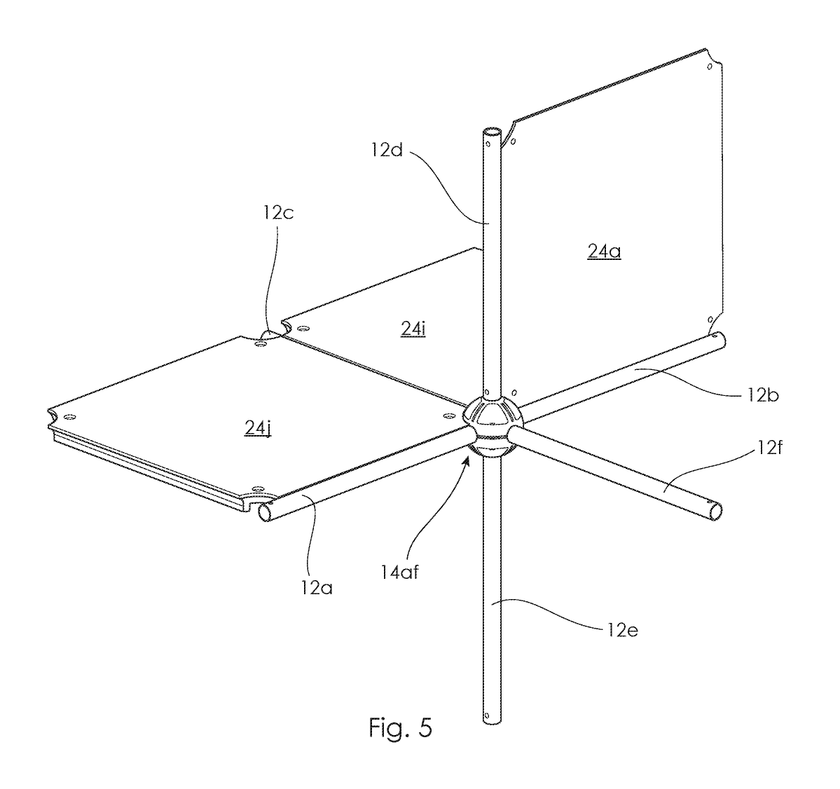

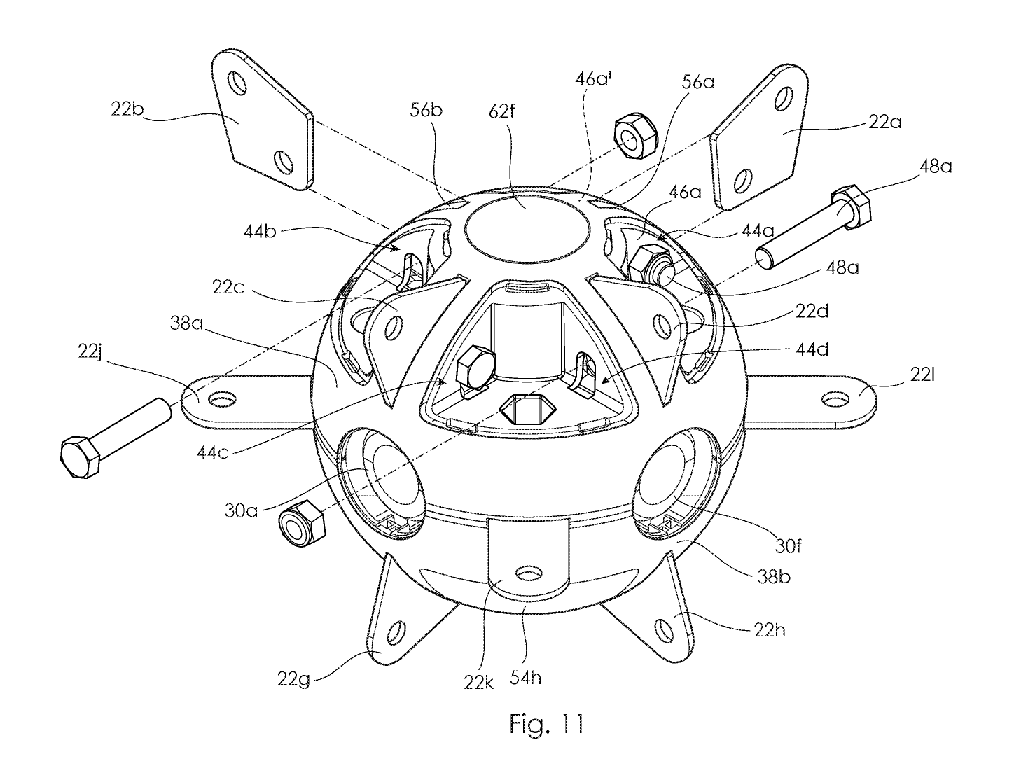

The general steps involved in assembly of the modular playground 10 of this embodiment are as follows (noting that the order of one or more of the steps may be altered):
1. the rail members such as 12a and 12b are fastened to the structural hub 16 by securing to respective of the spigots 30a and 30b (as illustrated in FIG. 3, for example);
2. the structural hub 16 is enclosed with the joint housing 18 and the associated hemi-spherical shells 38a and 38b thereof, which are not finally clamped together until other rail members 12c and 12d are fastened to the structural hub 16 (see FIG. 4, for example);
3. one or more of the deck panel brackets 22i to 22l (as can be seen in FIG. 13 in particular) are clamped between the hemi-spherical shells 38a and 38b via deck mounting bolts such as 43k located within the respective mounting bosses such as 42k thereby clamping the hemi-spherical shells 38a and 38b together and the deck panel 24i can then be fastened to the bracket 22i (see FIG. 4, for example);
4. one or more additional wall panel brackets 22a to 22d and 22e to 22h are fastened to the joint housing 18, as illustrated in FIG. 11, for securement of the respective wall panels 24a, 24m, 24n (see FIGS. 5 and 6);
5. additional rail members 12e and 12f are fastened to the structural hub 16 at respective spigots 30e and 30f (see FIGS. 4 and 5), however, it is to be appreciated that the step of fastening additional rail members 12e and 12f, and any other rail members such as 12c to the structural hub 16, may be completed before one or more of the deck panel brackets 22i to 22l (as can be seen in FIG. 13 in particular) and the hemi-spherical shells 38a and 38b are clamped together as described above in step number 3;
6. additional deck panel brackets 22i to 22l and wall panel brackets 22a to 22h can be fastened to the joint housing 18 for securement of the respective deck and wall panels 24l and 24m (see FIG. 6);
7. a further rail joint assembly 14aj is connected to its associated rail members 12h and 12i for continued expansion of the modular playground 10 (see FIG. 6).

The modular playground 10 is thus constructed in a series of adjoining cubes depending on the configuration required and the space available. The construction steps and their order may vary where for example the framework 11 is substantially completed prior to attachment of the various deck panels 24i, 24j, 241 and wall panels 24a, 24m and 24n. In a general sense, albeit to some extent in a flexible order, part or all of the framework 11 comprising the rail members 12, such as rail members 12a, 12b, 12c, 12d, 12f, 12e, 12f, 12g, 12h, 12i, 12j (see FIGS. 1 to 6), are connected to the structural hub 16 of the joint assemblies 14af, 14aj before one or more of the deck panel brackets 22i to 22l (as can be seen in FIG. 13 in particular) are clamped between the hemi-spherical shells 38a and 38b which in turn also clamps the shells 38a, 38b together. Then, perhaps, a deck panel 24i could be fastened to the deck panel bracket 22i or one or more wall panel brackets 22a to 22d and 22e to 22h could be fastened to the joint housing 18, before then fastening deck panels 24i to the deck panel bracket 22i and fastening the wall panels 24a to the wall panel brackets 22a to 22h of the joint housing 18. The modular design of the rail joint assembly such as 14af and 14aj lends itself to this flexibility in construction where, for example:
1. Panel brackets such as 22a to 22l and their associated panels 24a to 24l can be added or removed using the relevant fasteners which are accessed internally of the joint housing 18 via one or more of the window openings such as 52a to 52h;
2. Rail members such as 12j may be added or removed by separating the hemi-spherical shells 38a and 38b to provide access to the structural hub 16 for fastening of the rail member such as 12j to the selected spigot 30j.

The hemi-spherical shells 38a and 38b are fully enclosed using either the window cover members such as 54a or the rail port cover such as 62f once the playground 10 construction is complete. The playground 10 in this embodiment can be configured without dismantling the existing structure or for example disassembling the joint housing 18 of the rail joint assembly 15.

Now that several preferred embodiments of the invention have been described it will be apparent to those skilled in the art that the rail joint assembly and modular play apparatus have at least the following advantages over the prior art:
1. The rail joint assembly is a universal fitting which lends itself to reconfiguring the play apparatus without requiring different junctions or joining brackets depending on the configuration;
2. The play apparatus can be constructed without requiring any particular trade skills;
3. The modular nature of the play apparatus with effectively the same rail members, panels and rail joint assemblies means the play apparatus is relatively inexpensive to manufacture;
4. The play apparatus being of a modular design can be easily reconfigured to suit the specific space requirement.

Those skilled in the art will appreciate that the invention described herein is susceptible to variations and modifications other than those specifically described. For example, although the rail joint assembly lends itself to moulding in plastics it may be constructed from other materials. Similarly, although the load-bearing structural hub and rail members are preferably fabricated or cast in metal, such as aluminium, they may also be formed of different materials. The specific design of the rail joint assembly may vary provided it includes a structural hub and joint housing as broadly defined in this specification. All such variations and modifications are to be considered within the scope of the present invention the nature of which is to be determined from the foregoing description.

1. A play apparatus comprising:
a framework structure including interconnected rail members;
a plurality of joint assemblies each arranged to interconnect at least a pair of the rail members to construct the framework structure, each of the joint assemblies including:
a structural hub configured for detachable connection to an end of one of the rail members; and
a joint housing mounted about the structural hub and including one or more bracket anchorages for securement of one or more panel brackets to which a panel of the play apparatus is removably mounted.

2. The play apparatus of claim 1, wherein the structural hub includes a plurality of spigots each dedicated for connection to respective of the rail members associated with the rail joint assembly to construct the framework structure.

3. The play apparatus of claim 1, wherein the structural hub includes three intersecting pairs of the spigots arranged substantially orthogonal to each other with one spigot of the pair substantially aligned with the other spigot of the pair.

4. The play apparatus of claim 1, wherein the structural hub is formed in one-piece with the pairs of intersecting spigots extending from a core of the structural hub.

5. The play apparatus of claim 1, wherein the panel brackets each include a mounting tang which is generally elongate and configured for fastening at its opposite ends to the joint housing and the panel, respectively.

6. The play apparatus of claim 5, wherein the mounting tang is screw fastened or bolted to the joint housing to locate the mounting tang in substantially the same plane as the panel.

7. The play apparatus of claim 5, wherein the bracket anchorages include one or more flanged connections located inside the hollow housing and screw fastened or bolted to the mounting tang via bracket fasteners.

8. The play apparatus of claim 1, wherein the joint housing is substantially hollow and generally spherical in its outside shape.

9. The play apparatus of claim 8, wherein the spherical housing fully encloses the structural hub and includes rail openings for respective of the rail members associated with the rail joint assembly.

10. The play apparatus of claim 1, wherein the joint housing includes one or more window openings for access to the bracket anchorages to assist with securement of the panel bracket to which the panel is mounted.

11. The play apparatus of claim 10, wherein the window openings each include a cover member for closure of the respective window opening.

12. The play apparatus of claim 1, wherein the joint housing includes bracket openings designed for receipt of the panel bracket.

13. The play apparatus of claim 1, wherein the joint housing is of a two piece construction with opposing hemi-spherical shells being substantially the same and being secured to one another.

14. The play apparatus of claim 1, wherein the rail members are hollow and substantially straight.

15. The play apparatus of claim 1, wherein the framework defines the play apparatus in a series of adjoining cubes.

16. The play apparatus of claim 1, wherein the play apparatus is modular.

17. The play apparatus of claim 1, wherein the panel includes one or more arc shaped corners for closely adjoining the complementary shaped structural housing.

18. A rail joint assembly for a play apparatus, the nail joint assembly comprising:
a structural hub adapted for detachable connection to an end of a rail member of the play apparatus; and
a joint housing mounted about the structural hub and including one or more bracket anchorages for securement of at least one panel bracket to which a panel of the play apparatus is removably mounted.

19. A method for constructing a play apparatus comprising a framework structure of interconnected rail members and a plurality of joint assemblies, the method comprising:
connecting a structural hub to an end of one of the rail members;
mounting a joint housing about the structural hub to form a joint assembly;
securing one or more panel brackets to bracket anchorages of the joint housing;
and mounting one or more panels of the play apparatus to the panel brackets.

20. The method of claim 19, further comprising connecting the structural hub to the ends of a plurality of the rail members and clamping hemi-spherical shells of the joint housing together about the structural hub.
